(19) United States
(12) Patent Application Publication
(10) Pub. No.: US 2017/0065384 A1
(43) Pub. Date: Mar. 9, 2017

(54) Dental Hygiene Assembly

(71) Applicant: Jake Hampton, Placentia, CA (US)

(72) Inventor: Jake Hampton, Placentia, CA (US)

(21) Appl. No.: 14/845,857

(22) Filed: Sep. 4, 2015

(51) Int. Cl. A61C 15/04; A61C 19/06

(52) U.S. Cl. CPC A61C 15/041; A61C 19/06

(57) ABSTRACT

A dental hygiene assembly for cleaning and flossing teeth includes a pad that is infused with a liquid mouthwash. Thus, the pad may be wiped along a set of teeth and a tongue thereby facilitating the pad to clean the set of teeth and the tongue. A string is removably coupled to the pad such that the string may be removed from the pad.

### BACKGROUND OF THE DISCLOSURE

Field of the Disclosure

The disclosure relates to hygiene devices and more particularly pertains to a new hygiene device for cleaning and flossing teeth.

### SUMMARY OF THE DISCLOSURE

An embodiment of the disclosure meets the needs presented above by generally comprising a pad that is infused with a liquid mouthwash. Thus, the pad may be wiped along a set of teeth and a tongue thereby facilitating the pad to clean the set of teeth and the tongue. A string is removably coupled to the pad such that the string may be removed from the pad.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a dental hygiene assembly according to an embodiment of the disclosure.

FIG. 2 is a perspective view of an embodiment of the disclosure.

FIG. 3 is a back view of an embodiment of the disclosure.

FIG. 4 is a cross sectional view taken along line 4-4 of FIG. 3 of an embodiment of the disclosure.

FIG. 5 is a front perspective view of an embodiment of the disclosure.

### DESCRIPTION OF THE PREFERRED EMBODIMENT

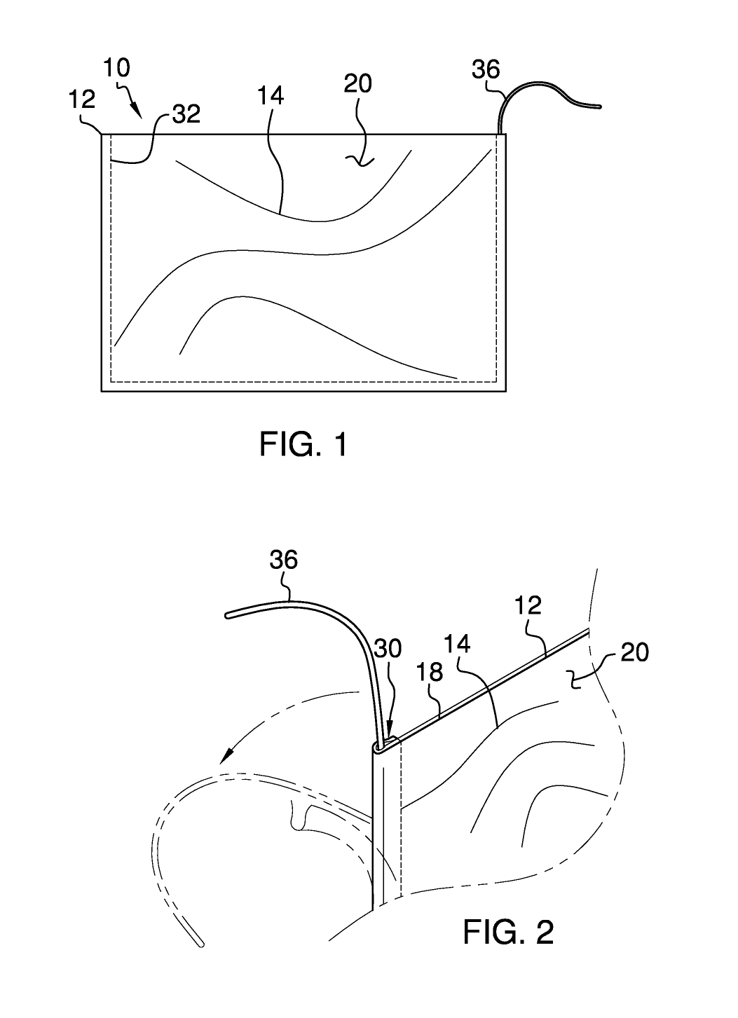

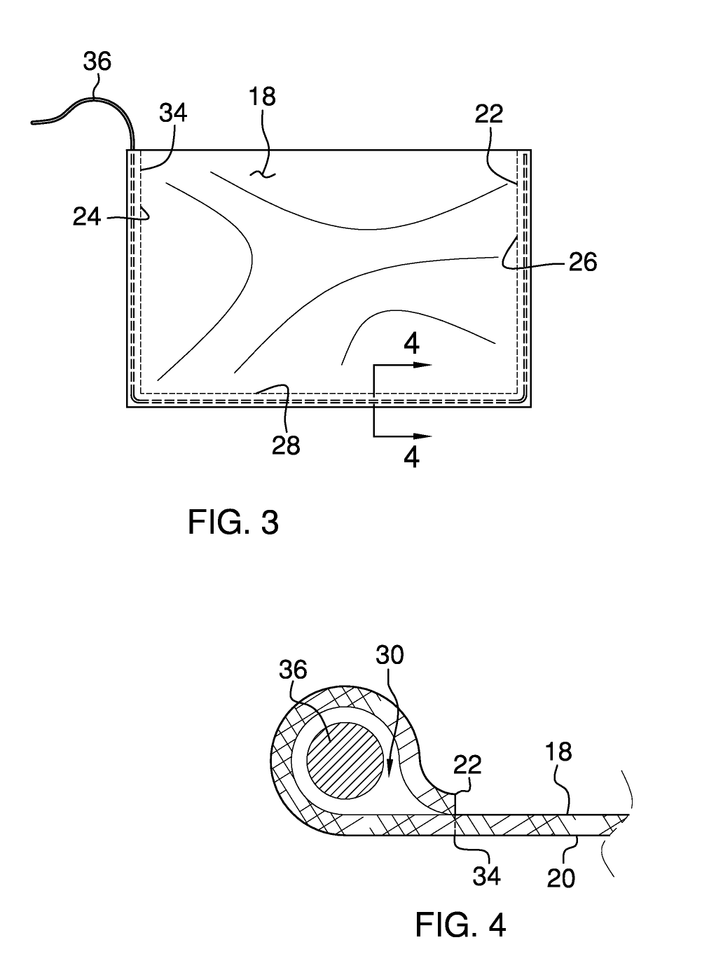

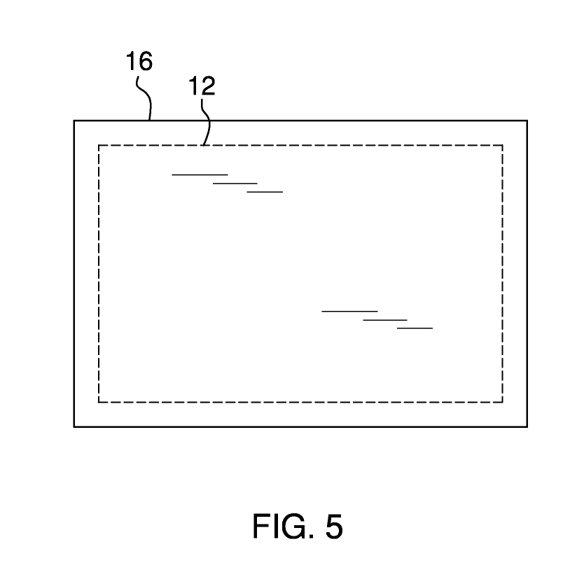

With reference now to the drawings, and in particular to FIGS. 1 through 5 thereof, a new hygiene device embodying the principles and concepts of an embodiment of the disclosure and generally designated by the reference numeral 10 will be described.

As best illustrated in FIGS. 1 through 5, the dental hygiene assembly 10 generally comprises a pad 12 that is infused with a liquid mouthwash 14. Thus, the pad 12 may be wiped along a set of teeth and a tongue thereby facilitating the pad to clean the set of teeth and the tongue. The liquid mouthwash 14 may have an herbal flavor or the like thereby facilitating the liquid mouthwash 14 to freshen the set of teeth and the tongue. A bag 16 is provided and the pad 12 is positioned within the bag 16. The bag 16 is closed thereby inhibiting the liquid mouthwash 14 from evaporating. The bag 16 is torn and the pad 12 is removed from the bag 16 when the pad 12 is to be utilized.

The pad 12 has a first surface 18, a second surface 20 and a peripheral edge 22 extending between the first surface 18 and the second surface 20. The peripheral edge 22 has a first lateral side 24, a second lateral side 26 and a bottom side 28. Each of the first lateral side 24, the second lateral side 26 and the bottom side 28 are folded onto the first surface 18 to form a pocket 30. The pocket 30 extends along the first lateral side 24, the second lateral side 26 and the bottom side 28.

The pad 12 has a stitch 32 extending through the first surface 18 and the second surface 20. The stitch 32 extends along the first lateral side 24, the second lateral side 26 and the bottom side 28. The stitch 32 creates a perforation 34 in the pad 12. Thus, the pocket 30 is selectively removable from the pad 12.

A string 36 is removably coupled to the pad 12 such that the string 36 may be removed from the pad 12. The string 36 is positioned within the pocket 30. The string 36 extends outwardly from pocket 30 such that the string 36 may be gripped. The string 36 tears the perforation 34 when the string 36 is gripped thereby facilitating the string 36 to be removed from the pad 12. The string 36 may comprise dental floss or the like. The string 36 may have a length ranging between approximately twenty five cm and thirty five cm.

In use, the bag 16 is torn and the pad 12 is removed from the bag 16. The pad 12 is wiped along the teeth and the tongue. The string 36 is gripped and the string 36 is urged away from the pad 12. The perforation 34 tears such the pocket 30 and the string 36 are removed from the pad 12. The string 36 is utilized in the convention of flossing teeth.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dental hygiene assembly comprising:
a pad being infused with a liquid mouthwash wherein said pad is configured to be wiped along a set of teeth and a tongue thereby facilitating said pad to clean the set of teeth and the tongue; and
a string being removably coupled to said pad wherein said string is configured to be removed from said pad.

2. The assembly according to claim 1, wherein said pad has a first surface, a second surface and a peripheral edge extending between said first surface and said second surface, said peripheral edge having a first lateral side, a second lateral side and a bottom side, each of said first lateral side, said second lateral side and said bottom side being folded onto said first surface to form a pocket extending along said first lateral side, said second lateral side and said bottom side.

3. The assembly according to claim 2, wherein said pad has a stitch extending through said first surface and said second surface, said stitch extending along said first lateral side, said second lateral side and said bottom side, said stitch creating a perforation in said pad such that said pocket is selectively removable from said pad.

4. The assembly according to claim 1, wherein:
said pad has a perforation and a pocket; and
said string is positioned within said pocket, said string extending outwardly from pocket wherein said string is configured to be gripped, said string tearing said perforation when said string is gripped thereby facilitating said string to be removed from said pad.

5. A dental hygiene assembly comprising:
a pad being infused with a liquid mouthwash wherein said pad is configured to be wiped along a set of teeth and a tongue thereby facilitating said pad to clean the set of teeth and the tongue, said pad having a first surface, a second surface and a peripheral edge extending between said first surface and said second surface, said peripheral edge having a first lateral side, a second lateral side and a bottom side, each of said first lateral side, said second lateral side and said bottom side being folded onto said first surface to form a pocket extending along said first lateral side, said second lateral side and said bottom side, said pad having a stitch extending through said first surface and said second surface, said stitch extending along said first lateral side, said second lateral side and said bottom side, said stitch creating a perforation in said pad such that said pocket is selectively removable from said pad; and
a string being removably coupled to said pad wherein said string is configured to be removed from said pad, said string being positioned within said pocket, said string extending outwardly from pocket wherein said string is configured to be gripped, said string tearing said perforation when said string is gripped thereby facilitating said string to be removed from said pad.
